(19) United States
(12) Patent Application Publication
(10) Pub. No.: US 2022/0316080 A1
(43) Pub. Date: Oct. 6, 2022

(54) METHOD FOR OPERATING A SYSTEM FOR ELECTROLYSIS, AND SYSTEM FOR ELECTROLYSIS

(71) Applicant: Linde GmbH, Pullach (DE)

(72) Inventors: Andreas PESCHEL, Wolfratshausen (DE); Benjamin HENTSCHEL, München (DE); Christian LIEBHART, Gaissach (DE)

(21) Appl. No.: 17/597,005

(22) PCT Filed: Nov. 20, 2020
(86) PCT No.: PCT/EP2020/025528

§ 371 Date: Dec. 22, 2021

(30) Foreign Application Priority Data
Dec. 13, 2019 (DE) 10 2019 008 670.8
Apr. 9, 2020 (EP) 20020167.1

(51) Int. Cl. C25B 9/65; H02M 7/04; C25B 15/08; C25B 1/04; C25B 1/23; C25B 1/34

(52) U.S. Cl. CPC C25B 9/65; H02M 7/04; C25B 15/085; C25B 1/04; C25B 1/23; C25B 1/34

(57) ABSTRACT

A method for operating a system for electrolysis in order to obtain at least one gaseous electrolysis product, in which system at least one electrolysis device is electrically connected to a power converter by means of a direct-voltage circuit, the power converter being connected to an alternating-voltage circuit in order to supply the at least one electrolysis device with electrically energy for the operation of the at least one electrolysis device, the power converter being operated by means of zero crossing control. The invention further relates to a system of this type.

The invention relates to a method for operating a system for electrolysis, for example for obtaining hydrogen or another gaseous electrolysis product, in which at least one electrolysis device is supplied with electrical energy via a power converter, and to such a system.

### PRIOR ART

In order to obtain hydrogen, so-called electrolysis can be used, in which, for example, water is split up by electrical energy into oxygen and hydrogen, i.e., gaseous electrolysis products or products of the underlying redox reaction. Water electrolysis is also referred to here. What are known as alkaline water electrolysis (or AEL for “alkaline electrolysis”) or so-called proton exchange membrane electrolysis (or PEM electrolysis for “Proton Exchange Membrane” electrolysis) then also come into consideration here. The fundamentals for this are known per se, e.g., from “Bessarabov et al: PEM electrolysis for Hydrogen production. CRC Press.” In addition, there is also the so-called SOEC (“Solid Oxide Electrolysis Cell”) and AEM (“Anion Exchange Membrane”) electrolysis, as well as proton-conducting high-temperature electrolysis, PCEs (Proton Ceramic electrolysers), e.g., approximately 400° C. to 700° C., see, for example, Vøllestad et al. “Mixed proton and electron conducting double perovskite anodes for stable and efficient tubular proton ceramic electrolysers” in Nature Materials, 2019.

In particular, those electrolysis technologies that take place at low temperatures, i.e., PEM, AELL and AEM electrolysis, are suitable due to the possibilities of flexible operation for supporting the transition of energy production to renewable energy. An operation of a corresponding system for electrolysis is suitable for this purpose, in which the required electrical energy is obtained from, for example, a power supply grid, such as the public power supply. However, so-called island grids also come into consideration if, for example, such a system is operated (directly) at a wind turbine or a wind farm with a plurality of wind turbines.

However, here, problems may occur due to retroactive effects on the power supply grid, and these retroactive effects are usually the stronger the smaller the power supply grid is.

The object of the present invention is therefore to specify improved possibilities for operating a system for electrolysis.

### Disclosure of the Invention

This task is solved by a method for operating a system for electrolysis and by such a system with the features of the independent claims. Embodiments are the subject matter of the dependent claims and of the description below.

### Advantages of the Invention

A method according to the invention serves to operate a system for electrolysis to obtain at least one gaseous electrolysis product, in which at least one electrolysis device is electrically connected to a power converter via a direct-voltage circuit (also referred to as a direct-voltage intermediate circuit). The power converter in turn is connected with an alternating-voltage circuit in order to supply the at least one electrolysis device with electrical energy for its operation. The alternating-voltage circuit can (directly) be a power supply grid, but it is typical and expedient when the alternating-voltage circuit is electrically connected to a power supply grid by means of a transformer. Thus, the typically very high alternating voltage in the power supply grid (at least when used on an industrial scale, a high voltage is typical) can be transformed down to a lower, required value of the alternating voltage.

The public power supply or a public power supply grid can be used as the power supply grid. However, it is also preferred if an island grid is used as the power supply grid, i.e., a (self-contained) power supply grid, such as a wind turbine or a wind farm with a multitude of wind turbines.

The power converter is necessary in order to convert the alternating voltage, as is typical of a power supply grid, into the direct voltage required for operating the electrolysis device(s). In this sense, a so-called inverter or AD-DC-converter can be used as the power converter. At this point, however, it should be noted that, in principle, the conversion of direct voltage into alternating voltage may also be possible with such a power converter.

Typically, such a power converter has semiconductor switches, such as IGBTs or thyristors or MOSFETs, which are correspondingly connected, usually in a so-called bridge circuit, and then controlled to convert the alternating voltage into a direct voltage.

Although, within the scope of the present application, the system is mainly described with respect to (only) one electrolysis device, such a system may also have a plurality of such electrolysis devices that are electrically connected to the power converter via the direct-voltage circuit or a direct-voltage circuit. It is also conceivable that, in addition or alternatively, further electrolysis devices are electrically connected via another direct-voltage circuit and another (similar) power converter and then, via this, to the transformer.

Furthermore, the system can preferably be used for water electrolysis, i.e., for obtaining hydrogen as a gaseous electrolysis product. In particular, the types of water electrolysis already mentioned at the outset come into consideration here. Likewise, however, the system can, additionally or alternatively, also be used for carbon dioxide electrolysis (CO₂ electrolysis) (this serves in particular to obtain CO or carbon monoxide as a gaseous electrolysis product) and/or for co-electrolysis (this serves in particular to obtain synthesis gas as a gaseous electrolysis product), in which carbon dioxide, or carbon dioxide and water, are converted into various products (in particular gaseous electrolysis products), such as CO, synthesis gas or also ethylene, ethanol, format. Chlorine-alkali electrolysis also comes into consideration. In addition, the system can particularly preferably be used for low-temperature electrolysis and/or for mid-temperature electrolysis and/or high-temperature electrolysis, as described in part at the outset. For example, the EPM, AEL and AEM are operated as low-temperature electrolysis more typically at less than 100° C., although temperatures of up to 130° C. are also possible and sometimes even very efficient. In the case of medium-temperature electrolysis, steam (and no liquid water) is generally used, temperatures between 150° C. and 400° C. being considered, for example. High-temperature electrolysis usually involves electrolysis using ceramic membranes, e.g., SOEC or the HT-PEM described, in a temperature range above 600° C. The individual electrolysis devices are then designed accordingly for this purpose. However, the specific type of electrolysis carried out with the system is less relevant to the present invention, as will become apparent from the following explanations; in particular, the present invention can be used with any type of electrolysis based on water and/or carbon dioxide as the feedstock and also for chlorine-alkali electrolysis (this is used in particular to obtain chlorine as a gaseous electrolysis product).

However, when the electrolysis device is supplied with electrical energy via the converter, feedback or repercussions occur in the alternating-voltage circuit or the power supply grid due to the operation of the converter and the control of the semiconductor switches it contains. These feedbacks or back-effects are primarily based on the harmonic oscillations (i.e., fundamental oscillation and in particular harmonics) in the alternating voltage, which arise from or in the rectification of the alternating voltage. The voltage regulation then typically takes place by means of a phase-cut control, but this in turn amplifies the (undesired) harmonic oscillations.

In the proposed method, the power converter is now operated by means of a vibration package control. In the case of the vibration package control, also referred to as wave packet control, in contrast to the phase-cut control, a pulse is connected only in or at least close to zero crossings. For this reason, this type of control system is also referred to as “Zero Crossing Control.” The switching process of a semiconductor switch thus takes place when the applied vibration of the alternating voltage is zero, or a switching process already triggered previously is delayed until such a zero crossing occurs. Current and voltage transients and thus harmonics are thereby at least largely avoided. In particular, a reduction in the voltage (with regard to the mean value or effective mean value) is thus also possible.

In this vibration package control, in particular, a full-wave control or a half-wave control can be used. In the case of full wave control, all periods of the frequency of the alternating voltage are always switched on or off. As a result, no identical components occur in the power consumption. Half-waves can also be connected to increase the continuity of the effective voltage. If direct-current components are to be avoided, it should be ensured that negative and positive half-waves occur equally frequently.

By using this vibration package control and the associated prevention or at least reduction of feedback or effects into the power supply grid, previously necessary filters (e.g., low-pass filters which filter out the frequencies of these harmonics) can be avoided. The efficiency of the operation of the system is thus increased. In addition, due to the now lower back-effects in the power supply grid, more and/or larger systems can also be operated for electrolysis via a power supply grid, because no or hardly any back-effects occur, which could cause disturbances elsewhere. The transition of the energy extraction to renewable energies already mentioned at the outset can thus be supported even better.

As already mentioned, a transformer is usually used to transform down the alternating voltage of the power supply grid to a value suitable for the power converter. In this case, it is then preferred if the transformer is operated using a tap changer.

Tap changers for transformers, in particular power transformers, serve to adjust the transmission ratio (the amplitude of the alternating voltage between input voltage and output voltage). For this purpose, the winding of the transformer on its upper or lower voltage side usually comprises a trunk winding and a regulating or step winding with a plurality of taps which are guided to the tap changer. The power control when connected in parallel can also be realized via the tap changer.

Tap changers are divided into on-load tap changers (OLTC) and no-load tap changers (NLTC), or DETC for de-energized tap changers or OCTC for off-circuit tap changers, wherein these terms are synonymous.

On-load tap changers are used for uninterruptible switching under load and can be divided into load selectors and load switches. Depending on the operating currents to be handled and the installation location in the transformer circuit, tap changers can be installed in a single-phase or three-phase manner. This means that a tap changer column switches either one or three phases. Three single-phase tap changers require more space than one three-phase tap changer. The use of three-phase tap changers usually presupposes the installation location at the star point of a star connection. Single-phase switches are usually required for larger currents, higher switching power, or for use in a delta circuit.

No-load tap changers in principle fulfill the same tasks as on-load tap changers but can only be adjusted without load or voltage. No-load tap changers are usually executed with a few stages and are often actuated only manually, although automated actuation is of course also possible. However, they are largely maintenance-free.

Due to the avoidance of feedbacks by the vibration package control used, no such retroactive effects also occur in the transformer and a particularly efficient and interference-free switching operation is made possible by means of the tap changer. The available, settable voltage range can be increased without (negative) effects on direct-current ripples.

The aforementioned full-wave control when providing the direct voltage by means of the power converter basically allows a voltage range of 0% to 100% of the input voltage as output voltage, if no negative effects on direct-current ripples are to be allowed, however, a voltage range of 70% to 100%, preferably 80% to 100%, is expedient (thus in particular a direct-current ripple can be kept low during electrolysis). A tap changer basically allows voltage ranges without limits at the bottom or above; however, a voltage range of 90% to 110% is economically preferred. These voltage ranges or operating ranges are sufficient to compensate for aging effects during the electrolysis or of an electrolysis device and to keep the extraction or production rate of, for example, hydrogen constant over the service life (and thus also its previous operating time) of the electrolysis device. In particular, however, the electrolysis device can also always be operated flexibly. In this respect, it is therefore particularly expedient to achieve a nominal capacity (ultimately corresponds to the extraction rate) of the electrolysis device for the gaseous electrolysis product even in the case of degradation over the service life.

The background here is that the voltage required for operating an electrolysis device at a certain production rate increases over time so that the voltage provided must be increased over time in order to keep the production rate constant (if possible). A certain flexibility of the operation is thus made possible, i.e., the production rate can be increased or reduced. Alternatively or additionally, it is also preferred to completely switch off or on individual stacks of an electrolysis device and/or individual electrolysis devices (especially in the case of a plurality of electrolysis devices) as required. Switching on or off individual stacks further increases the working range or enables an adaptation of the load range.

The subject matter of the invention is furthermore a system for the electrolysis to obtain at least one gaseous electrolysis product, with at least one electrolysis device and one power converter, wherein the at least one electrolysis device is electrically connected to the power converter via a direct-voltage circuit, wherein the power converter is electrically connectable or connected to an alternating-voltage circuit in order to supply the at least one electrolysis device with electrical energy for operation thereof, wherein the system is configured to operate the power converter by means of a vibration package control. With regard to the advantages and further preferred embodiments of the system, reference is made to the statements relating to the method, which apply here accordingly, in order to avoid repetition.

The invention is explained in more detail below with reference to the accompanying drawing, which shows a system according to a preferred embodiment of the present invention.

### BRIEF DESCRIPTION OF THE DRAWING

FIG. 1 schematically shows a system according to the invention in a preferred embodiment.

FIG. 2 schematically shows the operation of a vibration package control as used in the context of the present invention.

FIG. 3 schematically shows voltage curves for the operation of an electrolysis device that may be part of a system according to the invention.

### DETAILED DESCRIPTION OF THE DRAWING

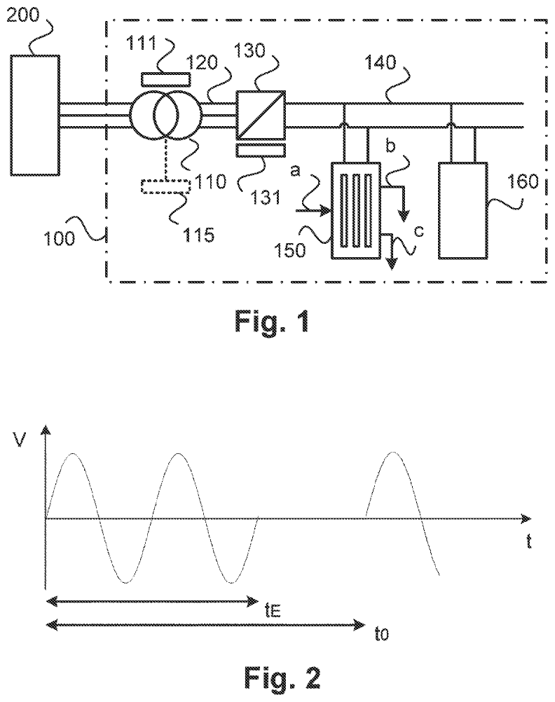

FIG. 1 schematically shows a system 100 according to the invention in a preferred embodiment. The system 100 is used for electrolysis and has a transformer 110, an alternating-voltage circuit 120, a power converter or inverter 130, a direct-voltage circuit 140 and, for example, two electrolysis devices 150 and 160. It goes without saying that even only one electrolysis device can be provided, or that even more electrolysis devices can be provided.

The transformer 110 has a tap changer 110, for example an on-load tap changer, and is electrically connected on the input side (or corresponding terminals) to a power supply grid 200 and on the output side (or corresponding other terminals) to the alternating-voltage circuit 120. The alternating voltage provided by the power supply grid 200 can thus be transformed down by means of the transformer 110, wherein the transformation ratio can be changed by using the tap changer 111.

The alternating-voltage circuit 120 is then electrically connected to the power converter 130 or corresponding terminals or input terminals of the power converter 130. The power converter 130 in turn is electrically connected to the direct-voltage circuit 140 via corresponding connections or output connections. The power converter 130 also has a control unit 131 by means of which semiconductor switches provided in the power converter can be activated accordingly, i.e., opened and closed, in order to rectify the alternating voltage. The electrolysis devices 150 and 160 are in turn electrically connected to the direct-voltage circuit 140.

In this way, electrical energy for operating the system 100 or the electrolysis devices 150, 160 comprised thereof can be provided by means of the power supply grid 200. By way of example, the electrolysis device 150 is designed for water electrolysis, in which water a is supplied and split into a plurality of stacks (only indicated) and hydrogen b and oxygen c are obtained and discharged as gaseous electrolysis products and optionally stored. It is also conceivable to (further) clean the gaseous electrolysis product, for example by drying and/or removing other gases. The electrolysis device 160 may have the same design or may also be different. As already mentioned at the outset, the specific type of electrolysis device is less relevant to the present invention; rather, the operation of the power converter 130 and possibly of the transformer 110 is important.

As mentioned, for operating the system 100, the power converter 130 or the semiconductor switches contained therein are controlled, in particular by means of the control unit 131, in such a way that the semiconductor switches always switch at or near a zero crossing of the relevant, applied vibration of the alternating voltage. The power converter 130 is thus operated by means of a vibration package control. The exact switching time does not have to be exactly at the zero crossing but can instead be up to 5% or up to 10% (relative to a period duration of the oscillation) before or after, for example.

In this way, feedback into the alternating-voltage circuit 120 and thus into the transformer 110 as well as the power supply grid 200 are prevented. A filter for reducing such undesired harmonics or feedback, as was previously necessary and shown in dashed lines in FIG. 1, cf. reference sign 115, is thus no longer necessary.

FIG. 2 schematically shows a control of the power converter with the vibration package control and thus its operation, as used in the context of the present invention. For this purpose, a voltage V is plotted over a time t, and vibrations or waves of the alternating voltage as they are present at the input of the power converter are shown.

For this purpose, t₀ shows a vibration package duration of three full or whole vibrations here by way of example; t_{E}, a switch-on duration of two full or whole vibrations here by way of example. It is hereby only switched at zero crossings, i.e., e.g., at t=0, t=t_{E} or t=t₀, so that no undesired harmonics can occur. In addition, this is only switched in the case of whole vibrations.

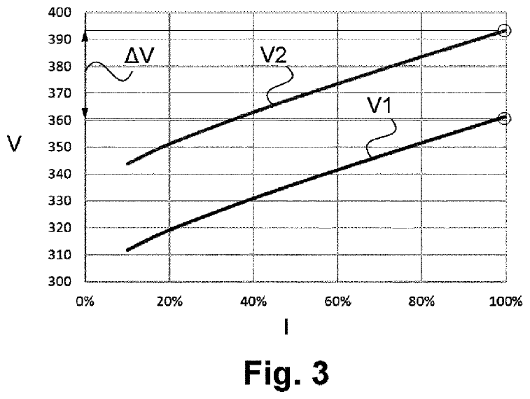

FIG. 3 shows schematic and purely exemplary or generic voltage curves for the operation of an electrolysis device, which can be part of a system according to the invention and is shown as an example in FIG. 1. For this purpose, a voltage V is applied above a current density I (instead, this can also be a density of hydrogen).

Curve V1 represents the relationship between the necessary voltage V and the current density I achieved therewith at the beginning of the service life of the electrolysis device, whereas curve V2 represents the corresponding relationship at the end of its service life. It can be seen that as the service life increases, an increasingly higher voltage is required here in order to achieve the same current density; the difference between the start and end of the service life is denoted here by ΔV.

Absolute values of the voltages usually vary in practice depending on the electrolysis technology and the number of cells in the stack of an electrolysis device. In this respect, as mentioned, only exemplary or generic curves are shown here. A slope also varies depending on electrolysis technology, insofar as they are likewise shown here only by way of example or generically.

However, by means of the above-described system and the proposed operation of such a system, it is possible to change the voltage applied to the electrolysis device and thus, for example, to select a lower voltage at the beginning of the service life, which is increased more and more over time in order to keep the current direction and thus also the production rate constant (if possible).

1-16. (canceled)

17. A method for operating a system for electrolysis to obtain at least one gaseous electrolysis product, in which system at least one electrolysis device is electrically connected to a power converter by means of a direct-voltage circuit, wherein the power converter is connected to an alternating-voltage circuit in order to supply the at least one electrolysis device with electrical energy for its operation,
wherein the power converter is operated by means of a vibration package control.

18. The method according to claim 17, wherein a full-wave control or a half-wave control is used in the vibration package control.

19. The method according to claim 17, wherein a full-wave control is used in the vibration package control, and wherein a voltage range of 70% to 100% of the input voltage is used as the output voltage.

20. The method according to claim 17, wherein the alternating-voltage circuit is electrically connected to a power supply grid by means of a transformer.

21. The method according to claim 19, wherein the transformer is operated using a tap changer (111).

22. The method according to claim 20, wherein the transformer is operated using an on-load tap changer or a no-load tap changer as a tap changer.

23. The method according to claim 20, wherein a voltage range of 90% to 110% is used in the transformer with the tap changer.

24. The method according to claim 20, in which a public power supply grid or an island grid is used as power supply grid.

25. The method according to claim 17, wherein a voltage provided for the at least one electrolysis device is adapted, in particular increased, as a function of a previous operating time.

26. The method according to claim 25, wherein the voltage provided for the at least one electrolysis device is adapted as a function of a previous operating time in order to achieve a nominal capacity (ultimately corresponds to the extraction rate) of the electrolysis device for the gaseous electrolysis product, even in the case of degradation over the service life.

27. The method according to claim 17, wherein one or more gaseous electrolysis products are discharged and, in particular, stored and/or purified.

28. The method according to claim 17, wherein one or more stacks of the at least one electrolysis device are switched on and/or off as required.

29. The method according to claim 17, wherein the system is used for water electrolysis to obtain hydrogen and/or for carbon dioxide electrolysis to obtain carbon monoxide and/or for co-electrolysis to obtain synthesis gas and/or for chlorine-alkali electrolysis to obtain chlorine.

30. The method according to claim 17, wherein the system is used for low-temperature electrolysis and/or for medium-temperature electrolysis and/or high-temperature electrolysis.

31. A system for electrolysis to obtain at least one gaseous electrolysis product, with at least one electrolysis device and one power converter, wherein the at least one electrolysis device is electrically connected to the power converter via a direct-voltage circuit, wherein the power converter is electrically connectable or connected to an alternating-voltage circuit in order to supply the at least one electrolysis device with electrical energy for its operation,
wherein the system is configured to operate the power converter by means of a vibration package control.

32. A system for electrolysis to obtain at least one gaseous electrolysis product, with at least one electrolysis device and one power converter, wherein the at least one electrolysis device is electrically connected to the power converter via a direct-voltage circuit, wherein the power converter is electrically connectable or connected to an alternating-voltage circuit in order to supply the at least one electrolysis device with electrical energy for its operation,
wherein the system is configured to operate the power converter by means of a vibration package control,
wherein the system is configured to perform the method according to claim 17.
